(19) United States
(12) Patent Application Publication
(10) Pub. No.: US 2008/0080209 A1
(43) Pub. Date: Apr. 3, 2008

(54) LAMP ASSEMBLY, BACKLIGHT ASSEMBLY INCLUDING THE SAME AND LIQUID CRYSTAL DISPLAY INCLUDING THE BACKLIGHT ASSEMBLY

(75) Inventors: Jin-soo SHIN, Cheonan-si (KR); Jun-hee Son, Cheonan-si (KR); Jeoung-gwen Lee, Suwon-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD., Suwon-si (KR)

(21) Appl. No.: 11/863,548

(22) Filed: Sep. 28, 2007

(30) Foreign Application Priority Data
Sep. 28, 2006 (KR) 10-2006-0095122

(51) Int. Cl. F21V 8/00; F21V 15/01

(52) U.S. Cl. 362/607; 362/362

(57) ABSTRACT

A lamp assembly includes a lamp emitting light, and a lamp cover formed in a U-shape and having a plurality of contact portions, wherein the plurality of contact portions are formed on at least one side of the lamp cover and are bent at an angle with respect to the at least one side of the lamp cover.

### CROSS REFERENCE TO RELATED APPLICATION

This application claims priority from Korean Patent Application No. 10-2006-0095122 filed on Sep. 28, 2006, the disclosure of which is incorporated herein by reference in its entirety.

### BACKGROUND OF THE INVENTION

1. Technical Field

The present disclosure relates to a lamp assembly, a backlight assembly including the lamp assembly and a liquid crystal display (LCD) including the backlight assembly, and more particularly, a lamp assembly capable of reducing a defective display of a liquid crystal display, a backlight assembly including the lamp assembly and a liquid crystal display including the backlight assembly.

2. Discussion of the Related Art

A liquid crystal display displays images using electrical and optical properties of liquid crystal disposed in a display panel. The liquid crystal display can be used in various fields of technology such as, for example, a computer monitor or a mobile phone, wherein characteristics of the liquid crystal display such as a compact size, light weight, and low power consumption are desired.

The liquid crystal display includes a display panel assembly and a backlight assembly. The backlight assembly can be located at the bottom side of the display panel, and supplies light to the display panel. The backlight assembly may comprise, for example, a lamp assembly, a light guide plate, and a receiving container receiving the light guide plate and the lamp assembly. The light guide plate can be located adjacent the lamp assembly, and guides light generated from a light source such as a lamp. A lamp cover can be partially inserted into a light cover. For example, a portion of the lamp assembly overlaps an upper or lower surface of the light guide plate. The lamp assembly and the light guide plate can be received together in the bottom receiving container.

When the liquid crystal display is subjected to external pressure, the lamp cover can be instantaneously separated from the bottom receiving container housing the lamp cover. As a result, an electromagnetic field is generated between the lamp cover and the bottom receiving container. The electromagnetic field causes electric current in, for example, a driving circuit part of the liquid crystal display to be instantaneously changed.

### SUMMARY OF THE INVENTION

According to an exemplary embodiment of the present invention, a lamp assembly comprises a lamp emitting light, and a lamp cover formed in a U-shape and having a plurality of contact portions, wherein the plurality of contact portions are formed on at least one side of the lamp cover and are bent at an angle with respect to the at least one side of the lamp cover.

According to an exemplary embodiment of the present invention, a liquid crystal display (LCD) comprises a display panel, and a backlight assembly providing light to the display panel, the back light assembly comprising a lamp assembly comprising a lamp emitting light, and a lamp cover formed in a U-shape and having a plurality of contact portions, the contact portions being formed by cutting a portion of at least one side of the lamp cover, wherein the contact portions are elastic and bent at an angle with respect to the at least one side, and a light guide plate inserted in the lamp cover and fixed therein, and optical sheets disposed on an upper side of the light guide plate, and a bottom receiving container receiving the lamp assembly, the light guide plate and the optical sheets, wherein the bottom receiving container contacts the plurality of contact portions.

According to an exemplary embodiment of the present invention, a liquid crystal display (LCD) comprises a display panel, and a backlight assembly providing light to the display panel, the back light assembly comprising a lamp assembly comprising a lamp emitting light, and a lamp cover formed in a U-shape and having a plurality of contact portions, the contact portions being formed by cutting a portion of at least one side of the lamp cover, wherein the contact portions are elastic and bent at an angle with respect to the at least one side, and a light guide plate inserted in the lamp cover and fixed therein, and optical sheets disposed on an upper side of the light guide plate, and a bottom receiving container receiving the lamp assembly, the light guide plate and the optical sheets, wherein the bottom receiving container contacts the plurality of contact portions.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of a backlight assembly including a lamp assembly according to an exemplary embodiment of the present invention;

FIG. 2 is a cross-sectional view illustrating the backlight assembly of FIG. 1 after the backlight assembly is assembled taken along the line II-II′;

FIG. 3 is a perspective view of a lamp assembly according to an exemplary embodiment of the present invention;

FIG. 4 is an enlarged view of the portion A of FIG. 3 according to an exemplary embodiment of the present invention;

FIG. 5 is a perspective view of a lamp assembly according an exemplary embodiment of the present invention;

FIG. 6 is an enlarged view of the portion B of FIG. 5 according to an exemplary embodiment of the present invention;

FIG. 7 is an enlarged view of the portion B of FIG. 5 according to an exemplary embodiment of the present invention;

FIG. 8 is a perspective view of a lamp assembly according to an exemplary embodiment of the present invention;

FIG. 9 is an enlarged view of the portion C of FIG. 8 according to an exemplary embodiment of the present invention;

FIG. 10 is an enlarged view of the portion C of FIG. 8 according to an exemplary embodiment of the present invention; and

FIG. 11 is an exploded perspective view of a liquid crystal display including a backlight assembly according to an exemplary embodiment of the present invention.

### DESCRIPTION OF EXEMPLARY EMBODIMENTS

The invention is described more fully hereinafter with reference to the accompanying drawings, in which exemplary embodiments of the invention are shown. The invention may, however, be embodied in many different forms and should not be construed as limited to the exemplary embodiments set forth herein.

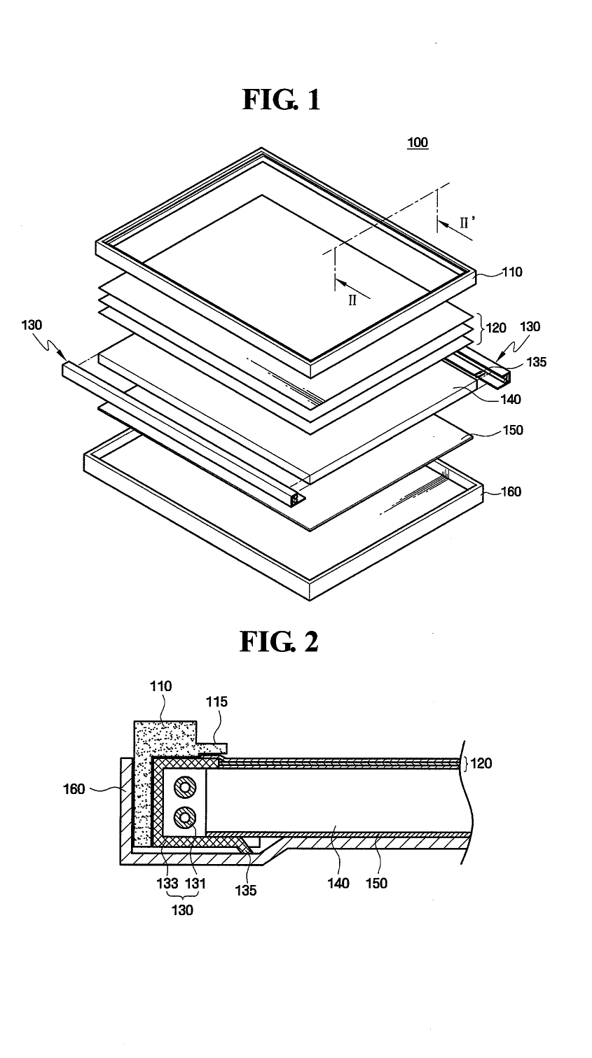

FIG. 1 is an exploded perspective view of a backlight assembly including a lamp assembly according to an exemplary embodiment of the present invention. FIG. 2 is a cross-sectional view illustrating the backlight assembly of FIG. 1 after the backlight assembly is assembled taken along the line II-II′.

Referring to FIGS. 1 and 2, a backlight assembly 100 includes a lamp assembly 130, a light guide plate 140, a reflective sheet 150, optical sheets 120, a mold frame 110 and a bottom receiving container 160.

The lamp assembly 130 may be disposed near a side of the light guide plate 140, and may comprise a lamp 131 and a lamp cover 133 surrounding the lamp 131. In an exemplary embodiment, the lamp 131 may comprise a line lamp such as a Cold Cathode Fluorescent Lamp (CCFL) or a Hot Cathode Fluorescent Lamp (HCFL), or a point lamp such as a Light Emitting Diode (LED).

The lamp assembly 130 may comprise, for example, a plurality of lamps 131, such as a pair of lamps. In an exemplary embodiment, the plurality of lamps 131 can be formed at constant intervals from each other on a component, for example, a transparent stationary ring (not shown) formed in the shape of numeral “8”.

The lamp cover 133 surrounds all or a substantial portion of the circumference of the lamp 131 to protect the lamp 131. The lamp cover 133 may be formed, for example, in a U-shape. The light guide plate 140 may be inserted into the lamp cover 133 and fixed therein. The lamp cover 133 is opened at a side facing the light guide plate 140, and the light guide plate 140 is inserted into the lamp cover 133 and fixed therein such that a portion of the upper and lower sides of the light guide plate 140 overlaps the lamp cover 133. The lamp cover 133 may comprise, for example, a metallic material such as aluminum.

The lamp cover 133 may further include a plurality of contact portions 135 contacting the bottom receiving container 160. The plurality of contact portions 135 can be formed by partially cutting a predetermined portion of at least one side of the lamp cover 133. In an exemplary embodiment, the contact portions 135 are bent in an outward direction from the lamp cover 133 at a predetermined angle and to contact the bottom receiving container 160. The contact portion 134 may have elastic characteristics. Accordingly, even though the lamp cover 133 is instantaneously separated from the bottom receiving container 160 due to, for example, an outside pressure applied on the backlight assembly 100, the lamp cover 133 sustains contact with the bottom receiving container 160 via the plurality of contact portions 135. Therefore, a defective display of the liquid crystal display can be reduced by preventing instantaneous changes of current generated when the lamp cover 133 is separated from the bottom receiving container 160.

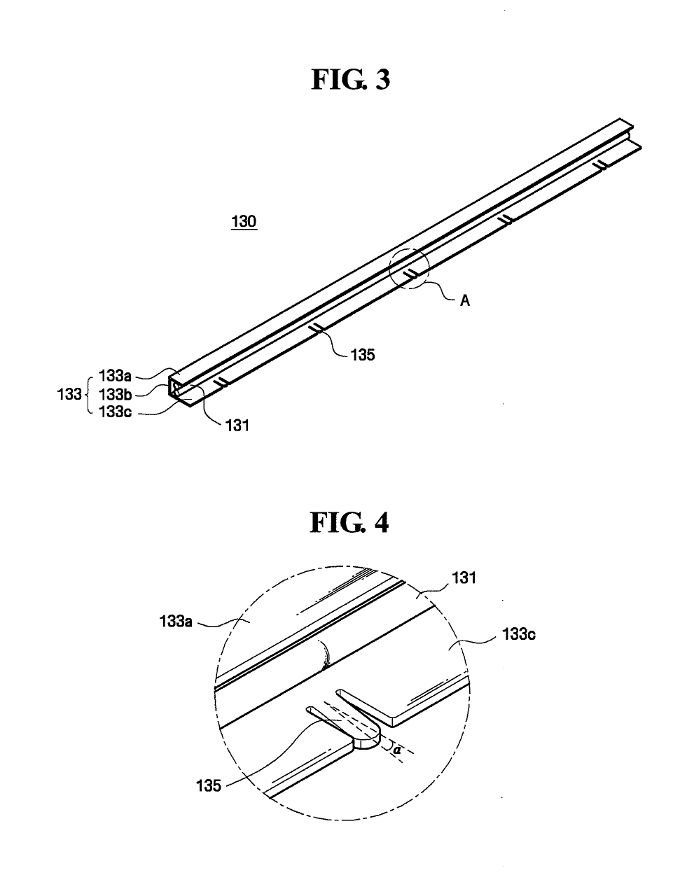

FIG. 3 is a perspective view of a lamp assembly of a backlight assembly according to an exemplary embodiment of the present invention. FIG. 4 is an enlarged view of the portion A of FIG. 3 according to an exemplary embodiment of the present invention.

Referring to FIGS. 2 through 4, the lamp assembly 130 may include the lamp 131 emitting light and the lamp cover 133 surrounding the lamp 131. The plurality of contact portions 135 may be formed in the lamp cover 133 to contact the bottom receiving container 160.

The lamp cover 133 may comprise an upper side 133a, a lateral side 133b and a lower side 133c. The lamp cover 133 may comprise a U-shape. The lateral side 133b of the lamp cover 133 vertically extends from an edge of the upper side 133a of the lamp cover 133. The lower side 133c of the lamp cover 133 is connected to the lateral side 133b of the lamp cover 133, and extends parallel to the upper side 133a of the lamp cover 133. In an exemplary embodiment, the lower side 133c of the lamp cover 133 may be larger than the upper side 133a of the lamp cover 133. The lower side 133c may extend further in a transverse direction than the upper side 133a of the lamp cover 133.

The plurality of contact portions 135 may be formed in the lower side 133c of the lamp cover 133. The contact portions 135 can be formed by cutting the lower side 133c of the lamp cover 133 at a predetermined interval, and by bending the cut portion downwardly, that is, in the outward direction of the lamp cover 133 at a predetermined angle of inclination. In an exemplary embodiment, the contact portions 135 are elastic and can be bent at the angle of inclination in the range of about 1° to about 10°. As shown in FIG. 2, the lamp cover 133 is received in the bottom receiving container 160, and the contact portions 135 formed in the lamp cover 133 contact the bottom surface of the bottom receiving container 160.

The contact portions 135 are separately formed at constant intervals in the lower side 133c of the lamp cover 133, and can be manufactured by, for example, a press process. In an exemplary embodiment, the contact portions 135 are spaced from each other at the same distance. In an exemplary embodiment, an edge in the length direction of the lower side 133c of the lamp cover 133 is cut inwardly at predetermined portions thereof and is bent. The lamp cover 133 including the contact portions 135 may comprise, for example, metallic materials such as aluminum or an aluminum alloy, in a thickness range of about 0.1 mm to about 0.3 mm.

The reflective part (not shown) may be formed with a predetermined thickness at the inner side of the lamp cover 133 that is adjacent to the lamp 131, the lower side 133c and the lateral side 133b. In an exemplary embodiment, the reflective part may be formed to have a thickness in a range of about 0.1 mm to about 0.3 mm. Light emitted from the lamp 131 is reflected to reach an incident portion of the light guide plate 140 which is inserted into the lamp cover 133 through the opened side thereof, thereby enhancing luminance of the backlight assembly 100. The reflective part may comprise, for example, an optical reflective resin such as a white polycarbonate.

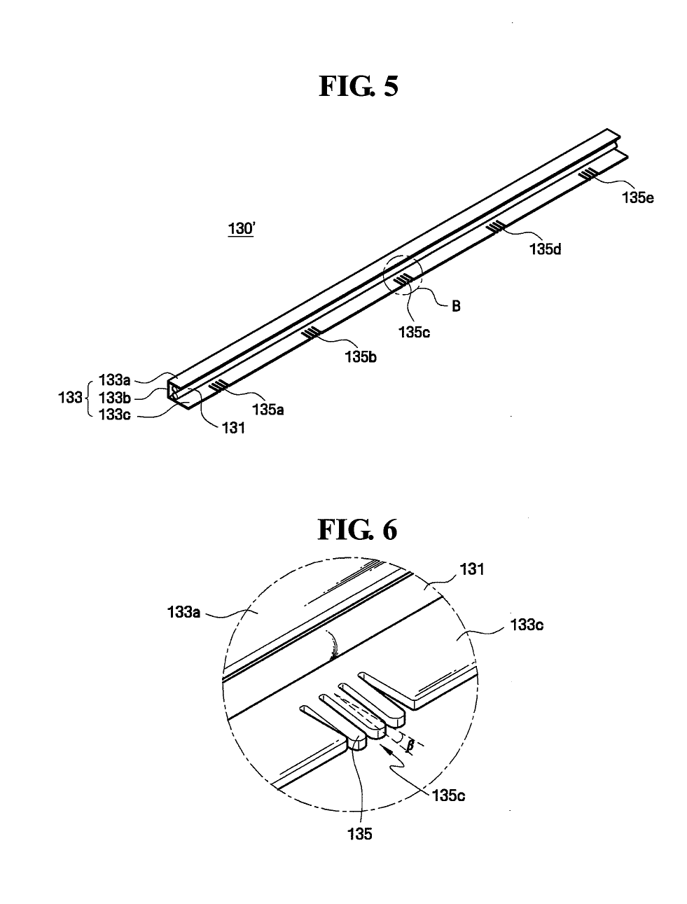

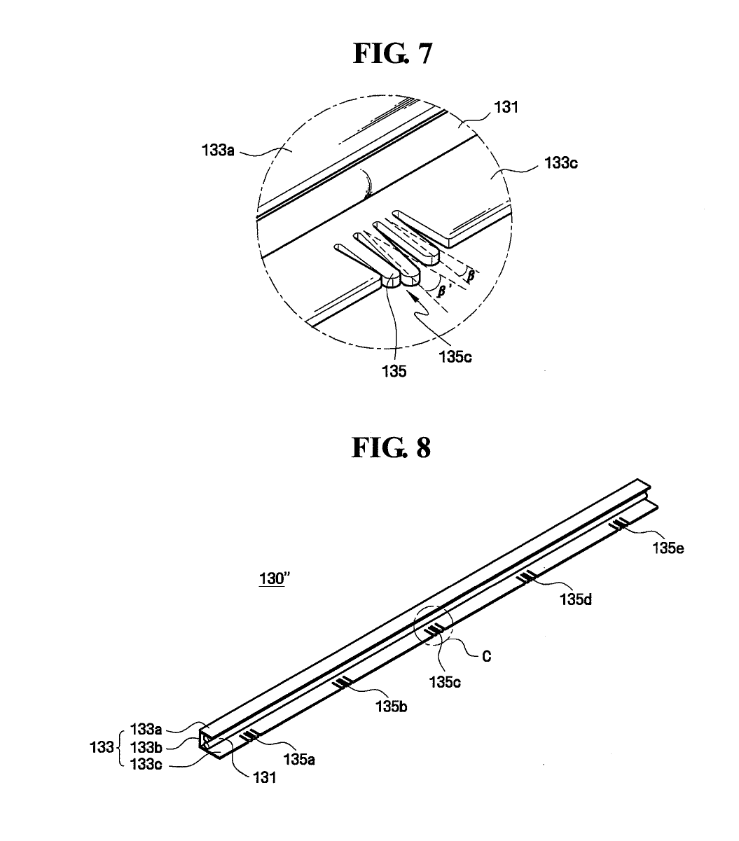

FIG. 5 is a perspective view of a lamp assembly according to an exemplary embodiment of the present invention. FIG. 6 is an enlarged view of the portion B of FIG. 5 according to an exemplary embodiment of the present invention. FIG. 7 is an enlarged view of the portion B of FIG. 5 according to an exemplary embodiment of the present invention.

Referring to FIGS. 2, 5, and 6, a lamp assembly 130′ includes the lamp 131 emitting light and the lamp cover 133 surrounding the lamp 131. The lamp cover 133 may comprise the upper side 133a, the lateral side 133b and the lower side 133c, and can be formed in a U-shape. The lateral side 133b vertically extends from an edge of the upper side 133a. The lower side 133c is connected to the lateral side 133b, and extends parallel to the upper side 133a. In an exemplary embodiment, the lower side 133c may be larger than the upper side 133a. The plurality of contact portions 135 may be formed in the lower side 133c of the lamp cover 133. The contact portions 135 form a plurality of groups 135a, 135b, 135c, 135d, and 135e, at constant intervals. In an exemplary embodiment, the interval between two adjacent groups is the same along a length of the lamp cover 133.

The plurality of contact portions 135 are formed in the lower side 133c of the lamp cover 133. A predetermined number of contact portions 135 adjacently located form one group, and a plurality of groups are disposed. The plurality of groups 135a, 135b, 135c, 135d, and 135e may be disposed at constant intervals in the lower side 133c of the lamp cover 133.

The contact portions 135 divided into the groups 135a, 135b, 135c, 135d, and 135e may be formed in a comb structure having an equal size to each other. That is, the contact portions 135 which are divided into the plurality of groups 135a, 135b, 135c, 135d, and 135e may be disposed in the lower side 133c of the lamp cover 133, and the contact portions 135 of each of the groups 135a, 135b, 135c, 135d, and 135e may be formed to have an equal size.

The contact portions 135 of each of the groups 135a, 135b, 135c, 135d, and 135e are bent in the outward direction of the lamp cover 133 at a predetermined angle of inclination As shown in FIG. 6, the contact portions 135 of each of the groups 135a, 135b, 135c, 135d, and 135e are bent in the outward direction of the lamp cover 133 at an equal angle of inclination. The contact portions 135 of each of the groups 135a, 135b, 135c, 135d, and 135e may be elastic and have the angle of inclination β in the range of about 1° to about 10°.

Referring to FIG. 7, the contact portions 135 of each of the groups 135a, 135b, 135c, 135d, and 135e may be bent at different angles β and β′. The contact portions 135 which are divided into the plurality of groups 135a, 135b, 135c, 135d, and 135e may be formed in the lower side 133c of the lamp cover 133, and the contact portions 135 of each of the groups 135a, 135b, 135c, 135d, and 135e may be formed to have an equal size. The contact portions 135 of each of the groups 135a, 135b, 135c, 135d, and 135e are bent in the outward direction from the lamp cover 133 at the predetermined angle of inclination β and β′.

The contact portions 135 of each of the groups 135a, 135b, 135c, 135d, and 135e may be bent in the outward direction from the lamp cover 133 at different angles of inclination β and β′. The contact portions 135 of each of the groups 135a, 135b, 135c, 135d, and 135e can be bent to form a semicircular shape. In other words, the contact portions 135 formed in each of the groups 135a, 135b, 135c, 135d, and 135e are bent at different angles of inclination β and β′ with respect to one contact portion 135 that is located at the center of each group. In an exemplary embodiment, one contact portion 135 located at the center of the contact portions 135 of each of the groups 135a, 135b, 135c, 135d, and 135e is bent with the larger inclination angle β′, and the other contact portions 135 located adjacent to the center contact portion 135 are bent with an inclination angle β, which is smaller than the angle β′, so that the contact portions 135 form a semicircular shape. The contact portions 135 bent at different angles of inclination β and β′ may have different elastic characteristics. In an exemplary embodiment, the contact portions 135 of each of the groups 135a, 135b, 135c, 135d, and 135e can be bent at the angle of inclination β and β′ in the range of about 1° to about 10°, respectively.

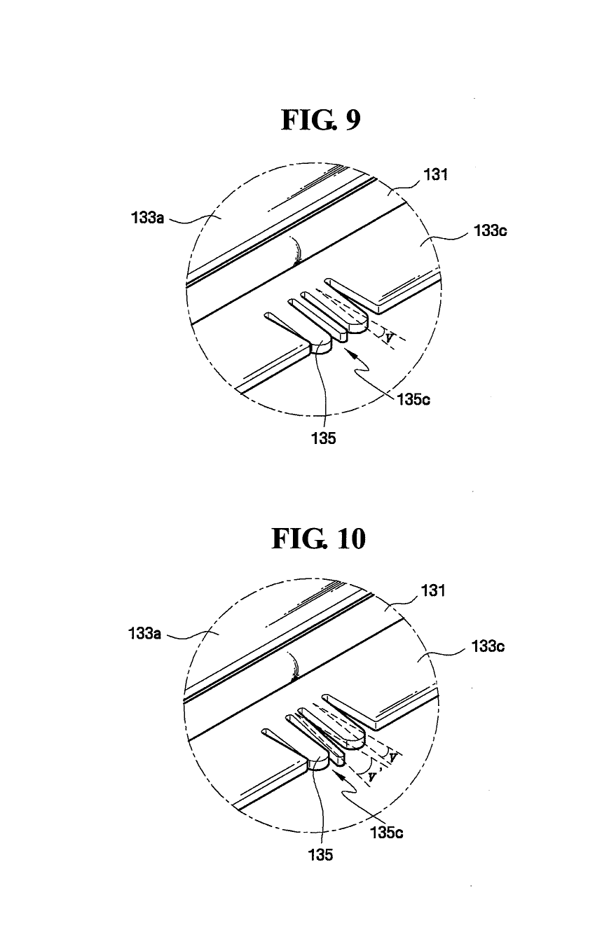

FIG. 8 is a perspective view of a lamp assembly according to an exemplary embodiment of the invention. FIG. 9 is an enlarged view of the portion C of FIG. 8 according to an exemplary embodiment of the present invention. FIG. 10 is an enlarged view of the portion C of FIG. 8 according to an exemplary embodiment of the present invention.

Referring to FIGS. 2, 8 and 9, a lamp assembly 130″ includes the lamp 131 emitting light and the lamp cover 133 receiving the lamp 131. The lamp cover 133 may comprise the upper side 133a, the lateral side 133b and the lower side 133c, and formed in a U-shape. The lateral side 133b vertically extends from an edge of the upper side 133a. The lower side 133c is connected to the lateral side 133b, and extends parallel to the upper side 133a. The lower side 133c may be larger than the upper side 133a. The plurality of contact portions 135 may be formed in the lower side 133c of the lamp cover 133. The contact portions 135 are formed in a plurality of groups 135a, 135b, 135c, 135d, and 135e, at constant intervals. For example, each group may be separated from an adjacent group at the same interval.

The plurality of contact portions 135 are formed in the lower side 133c of the lamp cover 133. The contact portions 135 may be formed at an edge in the length direction of the lower side 133c of the lamp cover 133.

A predetermined number of contact portions 135, adjacently located with respect to each other and isolated from another predetermined number of contact portions 135, form a group. In an exemplary embodiment, the plurality of groups 135a, 135b, 135c, 135d, and 135e may be disposed in the lower side 133c of the lamp cover 133 at a constant interval.

The contact portions 135 divided into the plurality of groups 135a, 135b, 135c, 135d, and 135e may be formed in a comb shape in which each tooth has or some teeth have a different size. That is, the contact portions 135 divided into the plurality of groups 135a, 135b, 135c, 135d, and 135e may be disposed in the lower side 133c of the lamp cover 133. The contact portions 135 of each of the groups 135a, 135b, 135c, 135d, and 135e may be formed to have a different size. For example, one contact portion 135 disposed at the center of each of the groups 135a, 135b, 135c, 135d, and 135e may be formed to have a larger width than other contact portions 135 which are located adjacent to the center contact portion 135. Alternatively, one contact portion 135 disposed at the center of each of the groups 135a, 135b, 135c, 135d, and 135e may be formed to have a smaller width than other contact portions 135 which are located adjacent to the center contact portion 135.

The contact portions 135 belonging to each of the groups 135a, 135b, 135c, 135d, and 135e, which are formed to have different sizes, are bent at a predetermined angle of inclination γ in the outward direction from the lamp cover 133. As shown in FIG. 9, the contact portions 135 of each of the groups 135a, 135b, 135c, 135d, and 135e may be bent at an equal angle of inclination γ in the outward direction of the lamp cover 133. In an exemplary embodiment, the contact portions 135 of each of the groups 135a, 135b, 135c, 135d, and 135e may be elastic and have an angle of inclination γ in the range of about 1° to about 10°.

Referring to FIG. 10, the contact portions 135 of each of the groups 135a, 135b, 135c, 135d, and 135e may be bent in the outward direction from the lamp cover 133 at different angles of inclination γ and γ′. The contact portions 135 of each of the groups 135a, 135b, 135c, 135d, and 135e may be bent such that the contact portions 135 formed with different sizes to each other form a semicircular structure. The contact portions 135 of each of the groups 135a, 135b, 135c, 135d, and 135e may be bent with respect to one contact portion 135 disposed at the center of the contact portions 135 having different angles of inclination γ and γ′. In an exemplary embodiment, one contact portion 135 located at the center of the contact portions 135 of each of the groups 135a, 135b, 135c, 135d, and 135e is bent with the larger inclination angle γ′, and the other contact portions 135 located adjacent to the center contact portion 135 is bent with an inclination angle γ, which is smaller than the angle γ′, so that the contact portions 135 form a semicircular shape. The contact portions 135 bent at different angles of inclination γ and γ′ may have different elastic characteristics. In an exemplary embodiment, the contact portions 135 of each of the groups 135a, 135b, 135c, 135d, and 135e can be bent at the angle of inclination γ and γ′ in the range of about 1° to about 10°, respectively.

Referring to FIGS. 1 and 2, the lamp assembly 130 may be disposed at a long side or a short side of the plate shaped light guide plate 140, and two lamp assemblies 130 may be disposed at sides adjacent to each other or sides disposed opposite to each other.

The light guide plate 140 may be inserted in the lamp cover 133 and fixed therein at one side of the lamp cover 133, and guides light emitted from the lamp assembly 130 to the upper side of the backlight assembly 100, for example, a display panel (not shown). The light guide plate 140 may comprise materials having good refractivity and transmissivity characteristics, such as PolyMethylMethAcrylate (PMMA), PolyCarbonate (PC), and PolyEthylene (PE). A scattering pattern (not shown) may be formed behind the light guide plate 140 to scatter light so that the scattering pattern may guide the light incident on the side surface of the light guide plate 140 upwardly. In an exemplary embodiment, a method of forming scattering patterns in the light guide plate 140 may use a method in which a scattering material is applied on the rear side of the light guide plate 140 and the scattering material is patterned. Alternatively, a method in which a constant wave is formed behind the light guide plate 140 can be used.

The reflective sheet 150 may be disposed behind the light guide plate 140. The reflective sheet 150 is located between the light guide plate 140 and the bottom receiving container 160 to reflect the light leaked through the rear side of the light guide plate 140 to the upper side of the light guide plate 140. The reflective sheet 150 enhances luminance of the backlight assembly 100, and causes light to be uniformly output to the upper side of the light guide plate 140. In an exemplary embodiment, the reflective sheet 150 may comprise a material, having good elastic characteristics and light reflectivity, which can be used as a thin film. For example, PolyEthlene Terephthalate (PET) having a thickness of about 0.01 mm to about 5 mm can be used as the reflective sheet 150. In an exemplary embodiment, materials for the reflective sheet 150 may be formed by coating a reflective film for enhancing light reflectivity on a thin material having good elastic characteristics.

The optical sheets 120 may be disposed behind the light guide plate 140. The optical sheets 120 facilitate irradiating the light uniformly guided by the light guide plate 140 to the upper side of backlight assembly 100. The optical sheets 120 are formed by selectively laminating optical sheets such as, for example, one or more diffusing sheets, prism sheets, or protective sheets. In an exemplary embodiment, only one optical sheet may be disposed. Alternatively, a plurality of equally sized optical sheets may be disposed. The order of laminating optical sheets can be modified to enhance the uniformity of light. The optical sheets 120 may comprise, for example, transparent resin, such as acryl resin, polyurethane resin, or silicon resin.

The mold frame 110 is coupled with the bottom receiving container 160, and supports and/or receives the above-described lamp assembly 130, the light guide plate 140 and the reflective sheet 150. The mold frame 110 may have a support portion 115 along the edge of the upper side of the light guide plate 140. The support portion 115 contacts the display panel (not shown) and separates the display panel 210 from the light guide plate 140. Materials for the mold frame 110 may include synthetic resin or the like having insulating properties.

The bottom receiving container 160 has a receiving space therein to receive the mold frame 110, the reflective sheet 150, the light guide plate 140, the lamp assembly 130 and the optical sheets 120. The bottom receiving container 160 may comprise, for example, metallic materials such as aluminum or an aluminum alloy. The bottom surface of the bottom receiving container 160 may contact the contact portions 135 which are formed in the lamp cover 133.

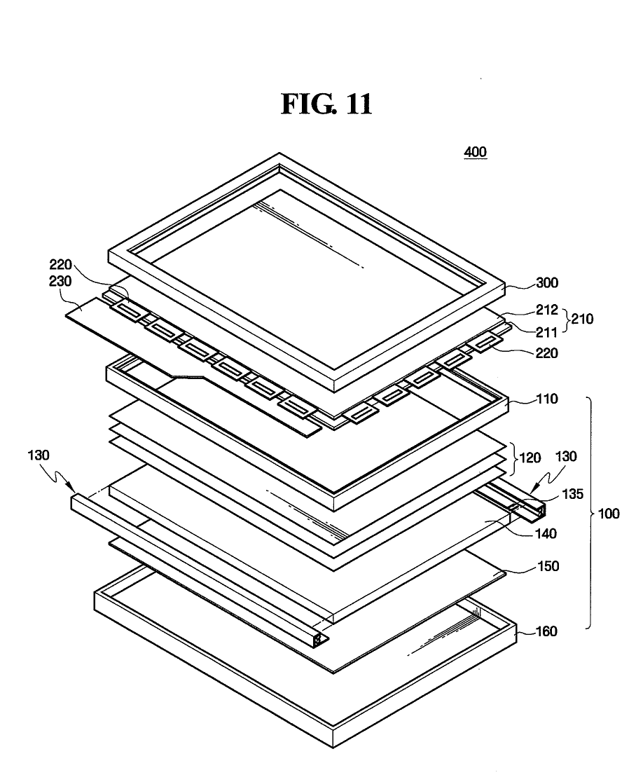

FIG. 11 is an exploded perspective view of a liquid crystal display including a backlight assembly according to an exemplary embodiment of the present invention.

Referring to FIG. 11, a liquid crystal display 400 may include, for example, a display panel 210, the backlight assembly 100, and a top receiving container 300.

The display panel 210 displays images, and includes a first display panel 211, a second display panel 212 and a liquid crystal layer (not shown) interposed between the first display panel 211 and the second display panel 212.

The first display panel 211 has a plurality of gate lines extending in a first direction at a constant interval, a plurality of data lines extending in a second direction to cross the gate lines and disposed at a constant interval, pixel electrodes formed in a matrix pattern in pixel regions defined by the gate lines and the data lines, and a thin film transistor switched by signals of the gate lines and transmitting the signals of the data lines to each of the pixel electrodes.

Images are formed on the second display panel 212 using a light blocking pattern for blocking portions of light except for the pixel regions, a red, green and blue (RGB) color pattern for displaying colors, and a common electrode used in connection with the RGB color pattern.

A constant interval can be sustained between the first display panel 211 and the second display panel 212 with a spacer (not shown) interposed therebetween. The first display panel 211 and the second display panel 212 can be joined by, for example, a sealant or frit glass.

A liquid crystal layer having an optically anisotropic property is formed between the first display panel 211 and the second display panel 212.

At one side of the display panel 210, a Printed Circuit Board (PCB) 230 is electrically connected to a Tape Carrier Package (TCP) 220. Electronic components generating driving and control signals of the display panel 210 are mounted on the PCB 230 by, for example, surface mount technology. A driving integrated circuit (IC) is mounted at the center of the TCP 220 to drive the display panel 210. The PCB 230 and the TCP 220 apply driving signals and timing signals to the gate lines and data lines of the first display panel 211 to control an angle for arrangement of the liquid crystals and timing for arrangement of the liquid crystals. The PCB 230 is bent toward the rear side of the bottom receiving container 160 to be coupled with or fixed to the bottom receiving container 160.

The backlight assembly 100 is located at the lower side of the display panel 210 to supply light to the display panel 210. The backlight assembly 100 may include the lamp assembly 130, the light guide plate 140, the reflective sheet 150, the optical sheets 120, the mold frame 110, and the bottom receiving container 160.

The top receiving container 300 is coupled with the bottom receiving container 160 of the backlight assembly 100 to receive the display panel 210 and the backlight assembly 100, and defines an effective display region of the display panel 210. The top receiving container 300 may be coupled with the bottom receiving container 160 by, for example, a hook coupling, and the coupling of the top receiving container 300 and the bottom receiving container 160 may be modified by using known methods such as, for example, a hook coupling and screw coupling.

According to an exemplary embodiment of the present invention, since the lamp cover contacts the bottom receiving container, it is possible to reduce a defective display of the liquid crystal display device generated when the lamp cover is separated from the bottom receiving container due to, for example, external pressure.

According to an exemplary embodiment of the present invention, when the lamp cover is disposed in the bottom receiving container, a screw or a conductive tape can be omitted.

Although the illustrative embodiments of the present invention have been described herein with reference to the accompanying drawings, it is to be understood that the present invention should not be limited to those precise embodiments and that various other changes and modifications may be affected herein by one of ordinary skill in the related art without departing from the scope or spirit of the invention. All such changes and modifications are intended to be included with the scope of the invention as defined by the appended claims.

What is claimed is:

1. A lamp assembly comprising:
a lamp emitting light; and
a lamp cover formed in a U-shape and having a plurality of contact portions,
wherein the plurality of contact portions are formed on at least one side of the lamp cover and are bent at an angle with respect to the at least one side of the lamp cover.

2. The lamp assembly of claim 1, wherein the plurality of contact portions are formed by cutting a portion of the at least one side of the lamp cover.

3. The lamp assembly of claim 1, wherein the plurality of contact portions are elastic.

4. The lamp assembly of claim 1, wherein:
the lamp cover comprises an upper side, a lateral side extended substantially perpendicular to the upper side from an edge of the upper side, and a lower side extended substantially parallel to the upper side from the lateral side, the lower side being larger than the upper side; and
the plurality of contact portions are formed at an edge of the lower side, wherein the contact portions are extended in a first direction substantially perpendicular with respect to an extension direction of the edge.

5. The lamp assembly of claim 4, wherein:
a number of the contact portions located adjacent to each other form a group;
a plurality of groups are disposed at constant intervals; and
the contact portions of each group are equally sized and are formed in a comb shape.

6. The lamp assembly of claim 5, wherein at least one of the contact portions of each group is bent at a different angle with respect to the at least one side than the remaining contact portions of the group.

7. The lamp assembly of claim 6, wherein a contact portion located at the center of each group is bent at a larger angle than the remaining contact portions of the group.

8. The lamp assembly of claim 4, wherein:
a number of the contact portions located adjacent to each other form a group;
a plurality of groups are disposed at constant intervals; and
the contact portions of each group are formed in a comb shape and comprises at least a contact portion having a different size compared to the remaining contact portions of the group.

9. The lamp assembly of claim 8, wherein at least one of the contact portions of each group is bent at a different angle with respect to the at least one side than the remaining contact portions of the group.

10. The lamp assembly of claim 9, wherein a contact portion located at the center of each group is bent at a larger angle than the remaining contact portions of the group.

11. The lamp assembly of claim 1, wherein the angle at which the plurality of contact portions are bent is in a range of about 1° to about 10°.

12. The lamp assembly of claim 1, wherein the plurality of contact portions are formed with a thickness in a range of about 0.1 mm to about 0.3 mm.

13. A backlight assembly comprising:
a lamp assembly comprising a lamp emitting light, and a lamp cover formed in a U-shape and having a plurality of contact portions, the contact portions being formed by cutting a portion of at least one side of the lamp cover, wherein the contact portions are elastic and at an angle with respect to the at least one side of the lamp;
a light guide plate inserted in the lamp cover and fixed therein;
optical sheets disposed on an upper side of the light guide plate; and
a bottom receiving container receiving the lamp assembly, the light guide plate and the optical sheets, wherein the bottom receiving container contacts the plurality of contact portions.

14. The backlight assembly of claim 13, wherein:
the lamp cover comprises an upper side, a lateral side extended substantially perpendicular to the upper side from an edge of the upper side, and a lower side extended substantially parallel to the upper side from the lateral side to be larger than the upper side, the lower side contacting the bottom surface of the bottom receiving container; and
the contact portions are formed at an edge of the lower side, wherein the contact portions are extended in a first direction substantially perpendicular with respect to an extension direction of the lower edge.

15. The backlight assembly of claim 14, wherein:
the plurality of contact portions located adjacent to each other form a group;
a plurality of groups are disposed at constant intervals; and
the contact portions of each group are equally sized and are formed in a comb shape.

16. The backlight assembly of claim 15, wherein a contact portion located at the center of each group is bent at a larger angle than the remaining contact portions of the group.

17. The backlight assembly of claim 14, wherein:
contact portions adjacent to each other form a group; a plurality of groups are disposed at constant intervals; and
the contact portions of each group are formed in a comb shape and comprises at least a contact portion having a different size compared to the remaining contact portions of the group.

18. The backlight assembly of claim 17, wherein a contact portion located at the center of each group has the largest angle of inclination.

19. The backlight assembly of claim 13, wherein the angle at which the plurality of contact portions are bent is in a range of about 1° to about 10°.

20. The backlight assembly of claim 13, wherein the plurality of contact portions are formed with a thickness in a range of about 0.1 mm to about 0.3 mm.

21. A liquid crystal display (LCD) comprising:
a display panel; and
a backlight assembly providing light to the display panel, the back light assembly comprising
a lamp assembly comprising:
a lamp emitting light; and
a lamp cover formed in a U-shape and having a plurality of contact portions, the contact portions being formed by cutting a portion of at least one side of the lamp cover, wherein the contact portions are elastic and bent at an angle with respect to the at least one side; and
a light guide plate inserted in the lamp cover and fixed therein; and
optical sheets disposed on an upper side of the light guide plate; and
a bottom receiving container receiving the lamp assembly, the light guide plate and the optical sheets, wherein the bottom receiving container contacts the plurality of contact portions.
